(19) United States
(12) Patent Application Publication
(10) Pub. No.: US 2018/0374265 A1
(43) Pub. Date: Dec. 27, 2018

(54) MIXED REALITY SIMULATION DEVICE AND COMPUTER READABLE MEDIUM

(71) Applicant: FANUC CORPORATION, Yamanashi (JP)

(72) Inventors: Makoto YAMADA, Yamanashi (JP); Kenshirou OONO, Yamanashi (JP)

(21) Appl. No.: 15/973,798

(22) Filed: May 8, 2018

(30) Foreign Application Priority Data
Jun. 22, 2017 (JP) 2017-122450

(51) Int. Cl. G06T 19/00; G06F 17/50

(52) U.S. Cl. CPC G06T 19/006; G06T 2219/004; G06F 17/5009

(57) ABSTRACT

An object is to provide a mixed reality simulation device and a mixed reality simulation program in which a mixed reality technology can be appropriately utilized so as to perform simulation. A mixed reality simulation device includes: a complex information display portion which three-dimensionally superimposes a virtual object on a real item to be arranged so as to display the virtual object; a distance measurement portion which measures a distance from the complex information display portion to the real item to be arranged; a virtual object relative movement portion which relatively moves, in the complex information display portion, the virtual object with respect to the real item to be arranged so as to display the virtual object; and a control portion which performs control on these portions.

This application is based on and claims the benefit of priority from Japanese Patent Application No. 2017-122450, filed on 22 Jun. 2017, the content of which is incorporated herein by reference.

### BACKGROUND OF THE INVENTION

### Field of the Invention

The present invention relates to a mixed reality simulation device and a computer readable medium for using a mixed reality technology so as to perform simulation.

### Related Art

When the introduction of a robot is examined in a factory facility, it is necessary to confirm interference between the robot and existing peripheral equipment. In order to perform this confirmation, for example, a technology is known in which an actual robot and an operation program for operating the robot are used so as to check interference between the peripheral equipment of the robot and the robot (see, for example, Patent Document 1). A technology is known in which the size of the peripheral equipment and the installation information of the peripheral equipment are measured as three-dimensional data and are captured in a simulator such as ROBOGUIDE (registered trademark) where simulation is performed, and a technology is also known in which simulation is performed by use of the device model of a virtual factory obtained by modelling resources such as the device of a factory with operation data and three-dimensional shape data (see, for example, Patent Document 2). A simulation method is also known in which constituent components are large and in which the large components of a large machine such as a significantly heavy press machine are disassembled and assembled (see, for example, Patent Document 3).
Patent Document 1: Japanese Unexamined Patent Application, Publication No. 2014-180707
Patent Document 2: Japanese Unexamined Patent Application, Publication No. 2000-081906
Patent Document 3: Japanese Unexamined Patent Application, Publication No. 2003-178332

### SUMMARY OF THE INVENTION

However, in the technology which is as disclosed in Patent Document 1 described above and which uses the actual robot and the operation program for operating the robot so as to check interference between the peripheral equipment of the robot and the robot, in order to confirm interference between the robot and the existing peripheral equipment, it is necessary to actually install the robot and operate the robot. Hence, it is not easy to confirm interference between the robot and the existing peripheral equipment.

In the method which is as disclosed in Patent Document 2 described above, which measures the size of the peripheral equipment and the installation information of the peripheral equipment as three-dimensional data and which captures it in the simulator so as to perform simulation, it requires a skill to measure the three-dimensional data. In other words, since in the measurement of the three-dimensional data, the result of the measurement is changed depending on an operator who performs the measurement, in order to obtain more accurate data, it is necessary to be performed by a skilled operator. Since the measurement of the three-dimensional data is manually performed, a measurement error may occur. Hence, due to a measurement error or an input error of the measured data, a measurement result in which items having no interference interfere with each other may be obtained. Furthermore, disadvantageously, it takes time to confirm interference between the robot and the peripheral equipment.

As disclosed in Patent Document 3 described above, it is difficult to use the simulation method in which the large components of the large machine are disassembled and assembled so as to check interference between the peripheral equipment of the robot and the robot without the simulation method being changed.

An object of the present invention is to provide a mixed reality simulation device and a mixed reality simulation program in which a mixed reality technology can be appropriately utilized so as to perform simulation.

(1) A mixed reality simulation device (for example, a mixed reality simulation device 1 which will be described later) of the present invention includes: a complex information display portion (for example, a HMD 300 which will be described later) which three-dimensionally superimposes a virtual object (for example, a virtual 3D object I which will be described later) on a real item to be arranged (for example, a real item to be arranged R which will be described later) so as to display the virtual object; a distance measurement portion (for example, a distance image sensor 200 which will be described later) which measures a distance from the complex information display portion to the real item to be arranged; a virtual object relative movement portion (for example, a controller 400 which will be described later) which relatively moves, in the complex information display portion, the virtual object with respect to the real item to be arranged so as to display the virtual object; and a control portion (for example, a control device 100 which will be described later) which performs control on the complex information display portion such that in the complex information display portion, the virtual object is three-dimensionally superimposed on the real item to be arranged so as to be displayed, and which performs control on the virtual object relative movement portion such that in the complex information display portion, the virtual object is relatively moved with respect to the real item to be arranged so as to be displayed.

(2) Preferably, in the mixed reality simulation device according to (1) described above, the virtual object includes a robot (for example, a virtual robot I1 which will be described later) and a region display (for example, a region display I2 which will be described later) indicating a range of an operation of the robot.

(2) Preferably, in the mixed reality simulation device according to (1) or (2) described above, information can be output which indicates a relative position relationship between the virtual object that is three-dimensionally superimposed on the real item to be arranged so as to be displayed in the complex information display portion and the real item to be arranged.

(4) Preferably, in the mixed reality simulation device according to any one of (1) to (3) described above, the complex information display portion is formed with a head mounted display.

(5) Preferably, in the mixed reality simulation device according to any one of (1) to (3) described above, the mixed reality simulation device is formed with a tablet-type terminal.

(6) A mixed reality simulation program of the present invention for making a computer function as a mixed reality simulation device makes the computer function as the mixed reality simulation device that includes: a complex information display portion which three-dimensionally superimposes a virtual object on a real item to be arranged so as to display the virtual object; a distance measurement portion which measures a distance from the complex information display portion to the real item to be arranged; a virtual object relative movement portion which relatively moves, in the complex information display portion, the virtual object with respect to the real item to be arranged so as to display the virtual object; and a control portion which performs control on the complex information display portion such that in the complex information display portion, the virtual object is three-dimensionally superimposed on the real item to be arranged so as to be displayed, and which performs control on the virtual object relative movement portion such that in the complex information display portion, the virtual object is relatively moved with respect to the real item to be arranged so as to be displayed.

According to the present invention, it is possible to provide a mixed reality simulation device and a mixed reality simulation program in which a mixed reality technology can be appropriately utilized so as to perform simulation.

### BRIEF DESCRIPTION OF THE DRAWINGS

FIG. 1 is a schematic view showing the overall configuration of a mixed reality simulation device 1 according to a first embodiment of the present invention;

FIG. 2 is a flowchart showing a method of performing a mixed reality simulation with the mixed reality simulation device 1 according to the first embodiment of the present invention; and

FIG. 3 is a conceptual view in which in the HMD 300 of the mixed reality simulation device 1 according to the first embodiment of the present invention, a picture where the virtual robot I1 of a virtual 3D object I is three-dimensionally superimposed on a real item to be arranged R so as to be displayed is seen in one direction.

### DETAILED DESCRIPTION OF THE INVENTION

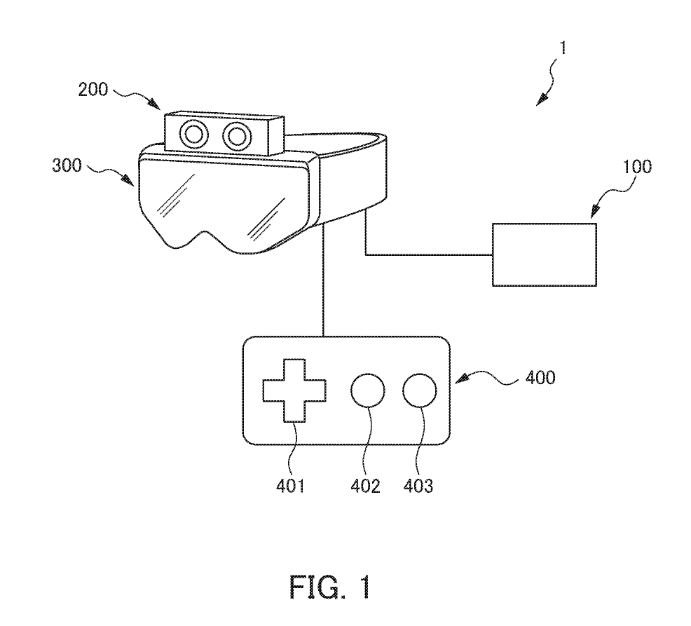

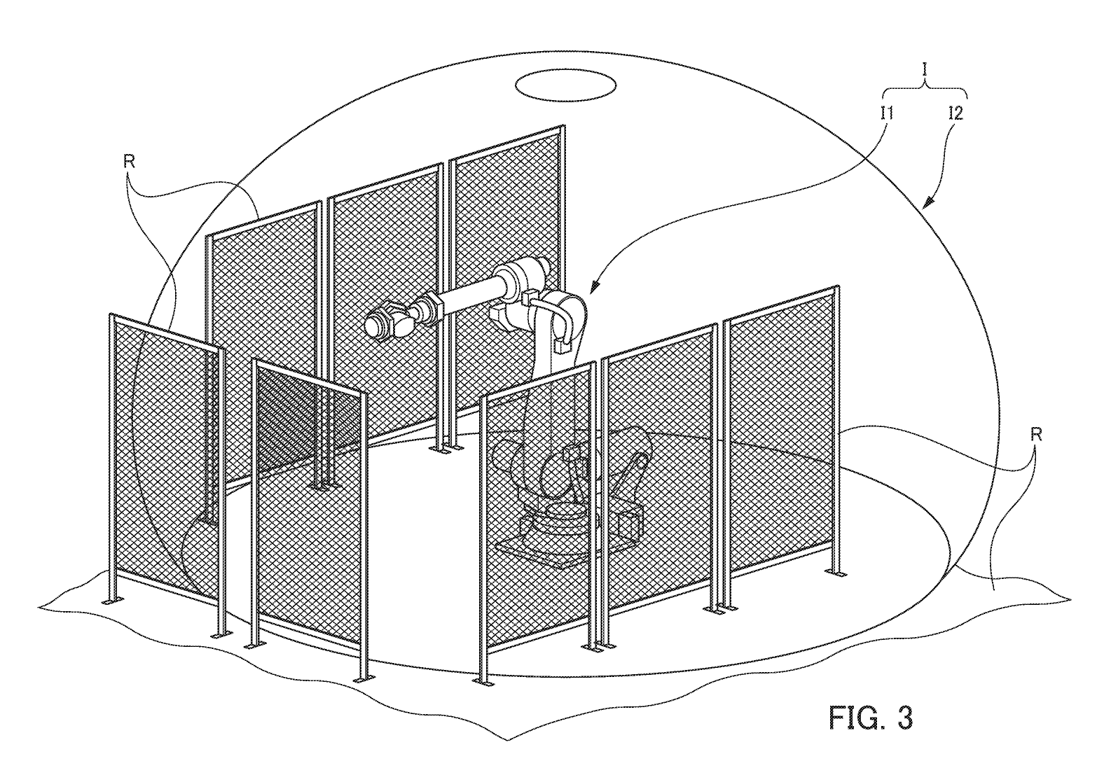

Embodiments of the present invention will then be described in detail with reference to drawings. FIG. 1 is a schematic view showing the overall configuration of a mixed reality simulation device 1 according to a first embodiment of the present invention. FIG. 3 is a conceptual view in which in the HMD 300 of the mixed reality simulation device 1 according to the first embodiment of the present invention, a picture where the virtual robot I1 of a virtual 3D object I is three-dimensionally superimposed on a real item to be arranged R so as to be displayed is seen in one direction.

The mixed reality simulation device 1 according to the present embodiment is a simulation device for confirming, when the introduction of a robot into a factory is examined, interference between the robot and the real item to be arranged R (see FIG. 3) such as existing peripheral equipment within the factory, and includes a control device 100 serving as a control portion, a distance image sensor 200 serving as a distance measurement portion, a head mounted display 300 (hereinafter referred to as the “HMD 300”) serving as a complex information display portion and a controller 400 serving as a virtual object relative movement portion.

The control device 100 performs control on the HMD 300 such that in the HMD 300, the virtual robot I1 of the virtual 3D object I (see FIG. 3) which will be described later is three-dimensionally superimposed on the real item to be arranged R so as to be displayed, and performs control on the controller 400 such that in the HMD 300, the virtual robot I1 is relatively moved with respect to the real item to be arranged R so as to be displayed.

Specifically, the control device 100 includes a computation processing device such as a CPU (Central Processing Unit). The control device 100 also includes an auxiliary storage device such as a HDD (hard disk drive) storing various types of programs or an SSD (solid state drive) and a main storage device such as a RAM (Random Access Memory) for storing data temporarily necessary for the execution of a program by the computation processing device. In the control device 100, the computation processing device reads the various types of programs from the auxiliary storage device, and performs computation processing based on the various types of programs while developing the various types of programs read to the main storage device. Then, the control device 100 controls, based on the result of the computation, hardware connected to the control device 100 so as to function as the mixed reality simulation device 1.

The control device 100 has the function of communicating with the HMD 300, the distance image sensor 200 and the controller 400, and the control device 100 is connected to the HMD 300, the distance image sensor 200 and the controller 400 so as to be able to communicate therewith.

Then, the control device 100 can output information indicating a relative position relationship between the robot (hereinafter referred to as the “virtual robot I1”) which is three-dimensionally superimposed on the real item to be arranged R in the HMD 300 so as to be displayed and which is not actually present and the real item to be arranged R. Specifically, the control device 100 can output data on a two-dimensional drawing (drawing in which a position relationship between the virtual robot I1 and the real item to be arranged R which are arranged on a horizontal plane is found) and data indicating a relative position relationship of the virtual robot I1 with respect to the real item to be arranged R, in other words, the control device 100 can output data indicating a position relationship like a “position 1 m 50 cm away from a wall”, while the virtual robot I1 is installed at an appropriate place having no interference with the real item to be arranged R.

The distance image sensor 200 is fixed to an upper portion of the HMD 300 and includes and uses a three-dimensional camera so as to capture the amount of variation in the position/posture of an operator. In other words, the distance image sensor 200 measures a distance from the HMD 300 to the real item to be arranged R so as to measure the current position of the HMD 300 by a three-dimensional measurement. More specifically, for example, by a time-of-flight (TOF) method, light is applied from a light source provided in the distance image sensor 200 to the real item to be arranged R, a time after the reflection of the light until the light is returned to the distance image sensor 200 is measured and thus the distance from the HMD 300 to the real item to be arranged R is measured.

Here, the real item to be arranged R means that in addition to the peripheral equipment which is arranged in reality in the vicinity of a position where the robot is to be installed within the factory, all items such as a floor surface and a fence in the factory which may interfere with the robot are included. Hence, with respect to all the area of all external surfaces which are present in front of the HMD 300 and which are opposite the HMD 300, the distance image sensor 200 evenly measures a distance from the HMD 300 to the external surface.

The HMD 300 is a general head mounted display. The HMD 300 three-dimensionally superimposes the virtual robot I1 on the real item to be arranged R so as to display the virtual robot I1, and thereby displays a mixed reality image as if the virtual robot I1 were present (installed) within a real space. For example, when the virtual robot I1 is large, with reference to the scale of the size of the virtual robot I1 which is displayed so as to be reduced, the real item to be arranged R is displayed on the same scale.

Specifically, the HMD 300 acquires the virtual robot I1 output by the control device 100 and the display position and the display angle thereof. Then, the HMD 300 displays, based on the acquired information, the virtual robot I1 on a display included in the HMD 300. The virtual robot I1 is displayed based on the distance data detected by the distance image sensor 200 such that a relative position relationship in the real space with respect to the real item to be arranged R is maintained.

In other words, the distance from the HMD 300 to the real item to be arranged R is constantly measured by the distance image sensor 200, and the position of the HMD 300 with respect to the real item to be arranged R is calculated. Hence, for example, the position in which (angle at which) the real item to be arranged R is seen through the HMD 300 is changed depending on whether the real item to be arranged R is seen in a predetermined position (angle) or the real item to be arranged R is seen in another position (angle), and thus the virtual robot I1 is displayed on the display of the HMD 300 such that the angle at which the virtual robot I1 is seen is changed accordingly.

The virtual 3D object I includes not only the virtual robot I1 but also a region display I2 which indicates the operation range of the virtual robot I1. In other words, part of the robot which is operated, that is, part of the robot to be installed, is operated not only on the outline of the robot but also within a predetermined region (within a predetermined space) outside the outline. When the robot is installed within the factory, it is necessary to confirm whether or not the real item to be arranged R interferes with the predetermined region as described above, and the predetermined region as described above is displayed as part of the virtual 3D object I. The region display I2 is displayed in a hemispherical shape around the virtual robot I1, and is displayed in, for example, a translucent red color such that it is possible to easily and visually recognize the region display I2.

The controller 400 is operated by the operator such that the virtual 3D object I displayed on the display of the HMD 300 is relatively moved with respect to the real item to be arranged R so as to be displayed.

Specifically, as shown in FIG. 1, the controller 400 includes a cross key 401, an A button 402 and a B button 403. The A button 402 is pressed by the operator so as to enter a mode in which the virtual 3D object I can be relatively moved with respect to the real item to be arranged R (hereinafter referred to as a “movable mode”). In the movable mode, in order to move the virtual 3D object I displayed on the display of the HMD 300 in a forward/backward direction or in a left/right direction, the operator presses any one of the four parts of the cross, in the cross key 401, and thus the virtual 3D object I is relatively moved with respect to the real item to be arranged R in the direction corresponding to the pressed part. After the virtual 3D object I displayed on the display of the HMD 300 is arranged in a predetermined position with respect to the real item to be arranged R, the B button 403 is pressed by the operator, and thus the relative position of the virtual 3D object I with respect to the real item to be arranged R is fixed.

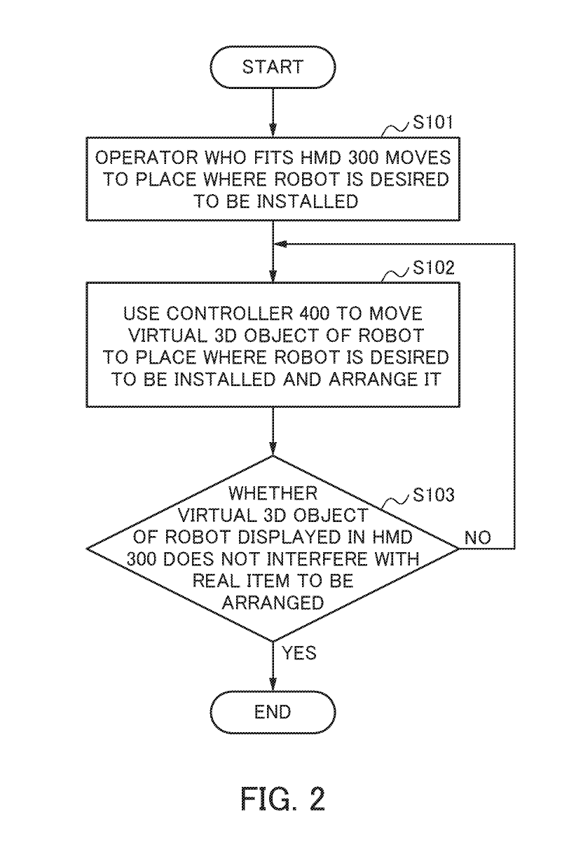

Then, a method of performing the mixed reality simulation using the mixed reality simulation device 1 will be described. FIG. 2 is a flowchart showing the method of performing the mixed reality simulation with the mixed reality simulation device 1 according to the first embodiment of the present invention.

First, in step S101, the operator fits the HMD 300 to the head so as to cover both eyes, and moves by walking himself while visually recognizing the real item to be arranged R which can be seen through the HMD 300. Then, the operator stops in the vicinity of a position in which the robot is desired to be installed.

Then, in step S102, the controller 400 is used so as to install the robot on a virtual space displayed in the HMD 300. The position/posture of the robot to be installed is expressed in the same coordinate system as a coordinate system on the position of the real item to be arranged R obtained by the distance image sensor 200, and is held within the HMD 300. Specifically, the operator presses the A button 402 in the controller 400 so as to enter the mode in which the virtual 3D object I can be moved with respect to the real item to be arranged R. Then, the operator presses any one of the four keys in the cross key 401 so as to move the virtual 3D object I in the direction corresponding to the key, and thereby arranges the virtual 3D object I of the robot in the position in which the robot is desired to be installed. Then, the operator presses the B button 403 in the controller 400 so as to fix the virtual 3D object I to the real item to be arranged R.

Then, in step S103, the operator moves by walking himself, and confirms, from various angles, a position relationship between the virtual robot I1 and the predetermined region display I2 of the virtual 3D object I and the real item to be arranged R so as to determine whether they interfere with each other. Here, the amount of movement of the operator is measured with the distance image sensor 200 and is output to the HMD 300. Then, the position/posture of the virtual robot I1 held in step S102 is corrected with the amount of movement output from the HMD 300 and is displayed in the HMD 300. In other words, by this correction, the display position and the display angle of the virtual robot I1 in the HMD 300 are changed according to the physical amount of movement of the operator. Hence, the position/posture of the virtual robot I1 on the real space is not changed.

Then, when in step S103, the operator sees, through the HMD 300, the virtual robot I1 and the predetermined region of the virtual 3D object I and the real item to be arranged R, and the operator determines that the virtual robot I1 and the predetermined region of the virtual 3D object I and the real item to be arranged R do not interfere with each other even when they are seen from any angle (yes), the operation in the method of performing the mixed reality simulation is completed. When in step S103, the operator determines that the virtual robot I1 and the predetermined region display I2 of the virtual 3D object I and the real item to be arranged R interfere with each other even when they are seen from any angle (no), the process is returned to step S102, and the position in which the virtual robot I1 is installed is changed.

The complex information display portion, the distance measurement portion, the virtual object relative movement portion and the control portion described above can be individually realized by hardware, software or a combination thereof. The method of the mixed reality simulation performed by cooperation of the complex information display portion, the distance measurement portion, the virtual object relative movement portion and the control portion described above can be realized by hardware, software or a combination thereof. Here, the realization by software means that the realization is achieved as a result of a computer reading and executing a program.

The program is stored by use of various types of non-transitory computer readable media and is supplied to a computer. The non-transitory computer readable media include various types of tangible storage media. The non-transitory computer readable media include magnetic storage media (for example, a flexible disk, a magnetic tape and a hard disk drive), magneto-optical storage media (for example, a magneto-optical disk), a CD-ROM (Read Only Memory), a CD-R, a CD-R/W, semiconductor memories (for example, a mask ROM, a PROM (Programmable ROM), an EPROM (Erasable PROM), a flash ROM and a RAM (random access memory). The program may be supplied to the computer by various types of transitory computer readable media. The transitory computer readable media include an electrical signal, an optical signal and an electromagnetic wave. The transitory computer readable medium can supply the program to the computer through a wired communication path such as an electric wire or an optical fiber or a wireless communication path.

The present embodiment described above has the following effects. In the present embodiment, the mixed reality simulation device 1 includes: the HMD 300 which three-dimensionally superimposes the virtual 3D object I on the real item to be arranged R so as to display the virtual 3D object I; the distance image sensor 200 which measures the distance from the HMD 300 to the real item to be arranged R; the controller 400 which relatively moves, in the HMD 300, the virtual 3D object I with respect to the real item to be arranged R so as to display it; and the control device 100 which performs control on the HMD 300 such that in the HMD 300, the virtual 3D object I is three-dimensionally superimposed on the real item to be arranged R so as to be displayed and which performs control on the controller 400 such that in the HMD 300, the virtual 3D object I is relatively moved with respect to the real item to be arranged R so as to be displayed.

In this way, in the HMD 300 of the mixed reality simulation device 1 including the distance image sensor 200, the virtual robot I1 can be virtually arranged on the real space so as to be displayed. Hence, in order to confirm a position relationship between the virtual 3D object I and the real item to be arranged R arranged within the real space, it is possible to visually recognize, while changing the viewpoint from various directions, the virtual 3D object I and the real item to be arranged R. Consequently, the operator can easily and visually confirm, in a place where the robot or the like is desired to be installed, whether or not the virtual 3D object I interferes with peripheral equipment and the like installed within the real space, the range of the operation of the virtual 3D object I and the like.

Hence, it is not necessary to perform an operation of measuring the three-dimensional data of the peripheral equipment and the like and capturing it in a simulator, and it is possible to confirm, at the site, in real time, interference between the virtual 3D object I and the real item to be arranged R such as the existing peripheral equipment. The interference checking is visually performed by the operator without use of a PC or the like, and thus the realization can be achieved inexpensively.

In the present embodiment, the virtual 3D object I includes the virtual robot I1 and the region display I2 indicating the range of the operation of the virtual robot I1. In this way, the operator can also easily and visually recognize, at the site, whether or not there is an item which interferes with the robot when the robot is actually installed and operated.

In the present embodiment, information can be output which indicates a relative position relationship between the virtual 3D object I that is three-dimensionally superimposed on the real item to be arranged R so as to be displayed in the HMD 300 and the real item to be arranged R. In this way, it is possible to store the information on the position where the robot can be installed which is obtained by the mixed reality simulation in the place where the robot or the like is desired to be installed. Then, based on the information thereof, the operator who installs the robot in the factory can easily install the robot in a predetermined installation place of the factory with high accuracy.

In the present embodiment, the complex information display portion is formed with the HMD 300. In this way, in the place where the robot is to be installed, the operator can confirm, through the HMD 300, while having an image as if the robot were actually installed within the real space, whether or not the virtual robot I1 interferes with the real item to be arranged R.

In the present embodiment, a mixed reality simulation program makes a computer formed with the control device 100 connected to the HMD 300, the distance image sensor 200 and the controller 400 function as the mixed reality simulation device 1, and the mixed reality simulation program makes the computer function as the mixed reality simulation device 1 that includes: the HMD 300 which three-dimensionally superimposes the virtual 3D object I on the real item to be arranged R so as to display the virtual 3D object I; the distance image sensor 200 which measures the distance from the HMD 300 to the real item to be arranged R; the controller 400 which relatively moves, in the HMD 300, the virtual 3D object I with respect to the real item to be arranged R so as to display it; and the control device 100 which performs control on the HMD 300 such that in the HMD 300, the virtual 3D object I is three-dimensionally superimposed on the real item to be arranged R so as to be displayed and which performs control on the controller 400 such that in the HMD 300, the virtual 3D object I is relatively moved with respect to the real item to be arranged R so as to be displayed.

In this way, the mixed reality simulation program is executed in the computer formed with the control device 100 connected to the HMD 300, the distance image sensor 200 and the controller 400, and thus it is possible to easily realize the mixed reality simulation device 1.

A second embodiment of the present invention will then be described.

The second embodiment differs from the first embodiment in that the mixed reality simulation device including the complex information display portion, the distance measurement portion, the virtual object relative movement portion and the control portion is formed with a tablet-type terminal. Since the other configurations are the same as those in the first embodiment, the description of the same configurations as in the first embodiment will be omitted.

The tablet-type terminal forms the mixed reality simulation device. Specifically, the monitor of the tablet-type terminal forms the complex information display portion. The monitor of the tablet-type terminal three-dimensionally superimposes the real item to be arranged whose image is sensed by a camera provided in the tablet-type terminal, and the virtual robot and the predetermined region indicating the range of the operation of the virtual robot on each other so as to display them.

The camera provided in the tablet-type terminal forms the distance measurement portion. A distance from the tablet-type terminal to the real item to be arranged is measured with the real item to be arranged whose image is sensed by the camera.

A touch panel forms the virtual object relative movement portion. The virtual 3D object displayed on the monitor of the tablet-type terminal is dragged so as to be moved on the touch panel, and thus the virtual 3D object is relatively moved on the monitor of the tablet-type terminal with respect to the real item to be arranged so as to be displayed.

A computation processing device such as a CPU in the tablet-type terminal forms the control portion. The computation processing device of the tablet-type terminal performs control on the monitor such that on the monitor, the virtual 3D object is three-dimensionally superimposed on the real item to be arranged so as to be displayed, and performs control on the touch panel of the monitor such that on the monitor, the virtual 3D object is relatively moved with respect to the real item to be arranged so as to be displayed.

As described above, the mixed reality simulation device is formed with the tablet-type terminal. Hence, the portability thereof is enhanced, and thus it is possible to easily perform the mixed reality simulation in various places.

The present embodiments have been described above. Although the embodiment described above is a preferred embodiment of the present invention, the range of the present invention is not limited to only the embodiment described above, and the present invention can be practiced in the form in which various modifications are made without departing from the spirit of the present invention. For example, as variations described below, variations can be performed and practiced.

For example, although in the present embodiments, the mixed reality simulation device is formed with the HMD 300 or the tablet-type terminal, there is no limitation to the present embodiments. The configurations of the individual portions such as the complex information display portion, the distance measurement portion, the virtual object relative movement portion and the control portion are not limited to the HMD 300, the distance image sensor 200, the controller 400, the control device 100 and the like in the present embodiments.

Likewise, although the virtual object includes the virtual robot and the region display indicating the range of the operation of the robot, there is no limitation to this configuration. For example, the real item to be arranged may be a machine tool, and in this case, the virtual object may be a work which serves as an item to be machined by the machine tool.

Although the distance image sensor 200 measures the distance from the HMD 300 to the real item to be arranged by the time-of-flight (TOF) method, there is no limitation to this configuration. For example, the distance from the complex information display portion to the real item to be arranged may be measured by laser. When the complex information display portion such as the HMD includes a measurement device for measuring the distance from complex information display portion to the real item to be arranged, the measurement device preferably forms the distance measurement portion.

When the complex information display portion includes an operation portion, the operation portion provided in the complex information display portion preferably forms the virtual object relative movement portion formed with the controller 400.

Although in the present embodiments, only one virtual robot is displayed, there is no limitation to this configuration. For example, a configuration may be adopted in which a plurality of virtual robots are displayed and can be moved individually and independently by the virtual object relative movement portion and in which the mixed reality simulation is performed as to whether or not one virtual robot does not interfere with the other virtual robot.

### EXPLANATION OF REFERENCE NUMERALS

1: mixed reality simulation device, 100: control device (control portion), 200: distance image sensor (distance measurement portion), 300: HMD (complex information display portion), 400: controller (virtual object relative movement portion), I: virtual 3D object, I1: virtual robot, I2: region display, R: real item to be arranged

What is claimed is:

1. A mixed reality simulation device comprising: a complex information display portion which three-dimensionally superimposes a virtual object on a real item to be arranged so as to display the virtual object;
a distance measurement portion which measures a distance from the complex information display portion to the real item to be arranged;
a virtual object relative movement portion which relatively moves, in the complex information display portion, the virtual object with respect to the real item to be arranged so as to display the virtual object; and
a control portion which performs control on the complex information display portion such that in the complex information display portion, the virtual object is three-dimensionally superimposed on the real item to be arranged so as to be displayed, and which performs control on the virtual object relative movement portion such that in the complex information display portion, the virtual object is relatively moved with respect to the real item to be arranged so as to be displayed.

2. The mixed reality simulation device according to claim 1, wherein the virtual object includes a robot and a region display indicating a range of an operation of the robot.

3. The mixed reality simulation device according to claim 1, wherein information can be output which indicates a relative position relationship between the virtual object that is three-dimensionally superimposed on the real item to be arranged so as to be displayed in the complex information display portion and the real item to be arranged.

4. The mixed reality simulation device according to claim 1, wherein the complex information display portion is formed with a head mounted display.

5. The mixed reality simulation device according to claim 1, wherein the mixed reality simulation device is formed with a tablet-type terminal.

6. A mixed reality simulation program for making a computer function as a mixed reality simulation device,
wherein the mixed reality simulation program makes the computer function as the mixed reality simulation device that includes:
a complex information display portion which three-dimensionally superimposes a virtual object on a real item to be arranged so as to display the virtual object;
a distance measurement portion which measures a distance from the complex information display portion to the real item to be arranged;
a virtual object relative movement portion which relatively moves, in the complex information display portion, the virtual object with respect to the real item to be arranged so as to display the virtual object; and
a control portion which performs control on the complex information display portion such that in the complex information display portion, the virtual object is three-dimensionally superimposed on the real item to be arranged so as to be displayed, and which performs control on the virtual object relative movement portion such that in the complex information display portion, the virtual object is relatively moved with respect to the real item to be arranged so as to be displayed.
